(19) United States
(12) Patent Application Publication
(10) Pub. No.: US 2022/0107476 A1
(43) Pub. Date: Apr. 7, 2022

(54) OPTICAL CONNECTOR CABLE AND METHOD FOR MANUFACTURING OPTICAL CONNECTOR CABLE

(71) Applicant: SUMITOMO ELECTRIC INDUSTRIES, LTD., Osaka (JP)

(72) Inventors: Takeshi INOUE, Osaka-shi (JP); Taisuke NAGASAKI, Osaka-shi (JP)

(73) Assignee: SUMITOMO ELECTRIC INDUSTRIES, LTD., Osaka (JP)

(21) Appl. No.: 17/492,055

(22) Filed: Oct. 1, 2021

(30) Foreign Application Priority Data
Oct. 6, 2020 (JP) 2020-168994

(51) Int. Cl. G02B 6/42

(52) U.S. Cl. CPC G02B 6/4239; G02B 6/4243

(57) ABSTRACT

An optical connector cable includes a plurality of optical fibers, a lens module, and an adhesive. The plurality of optical fibers extend in a first direction. The lens module has a placement portion, a facing surface, and a plurality of lenses. The placement portion places end portions of the plurality of optical fibers thereon in order in a second direction intersecting the first direction. The facing surface faces distal end surfaces of the plurality of optical fibers. The plurality of lenses are optically coupled to the plurality of optical fibers through the facing surface. The adhesive fixes the plurality of optical fibers to the placement portion. The plurality of optical fibers are placed on the placement portion such that the distal end surfaces are separated from the facing surface by predetermined distances, and a part of the adhesive enters spaces between the distal end surfaces and the facing surface.

### CROSS-REFERENCE TO RELATED APPLICATIONS

This application is based upon and claims the benefit of priority from Japanese Patent Application No. 2020-168994, filed on Oct. 6, 2020, the entire contents of which are incorporated herein by reference.

### TECHNICAL FIELD

The present disclosure relates to an optical connector cable and a method for manufacturing an optical connector cable.

### BACKGROUND

JP2016-035484A discloses an example of an optical connector cable including optical fibers and a lens module. The lens module is a member optically connecting the optical fibers to optical elements mounted on a circuit board. Fiber grooves for accommodating end portions of the optical fibers are provided in an upper portion of the lens module. An adhesive is injected into clearances between the fiber grooves and the end portions of the optical fibers accommodated in the fiber grooves, and thus the optical fibers are fixed to the lens module. U.S. Pat. No. 9,435,963B2 discloses another example of a lens module.

### SUMMARY

An optical connector cable of the present disclosure includes a plurality of optical fibers, a lens module, and an adhesive. The plurality of optical fibers each extend in a first direction. The lens module includes a placement portion, a facing surface, and a plurality of lenses. The placement portion is configured to place end portions of the plurality of optical fibers thereon in order in a second direction intersecting the first direction. The facing surface faces distal end surfaces of the plurality of optical fibers. The plurality of lenses are optically coupled to the plurality of optical fibers through the facing surface. The adhesive fixes the plurality of optical fibers to the placement portion. The plurality of respective optical fibers are placed on the placement portion such that the distal end surfaces are separated from the facing surface by predetermined distances, and a part of the adhesive enters spaces between the distal end surfaces and the facing surface.

### BRIEF DESCRIPTION OF THE DRAWINGS

The foregoing and other purposes, aspects and advantages will be better understood from the following detailed description of embodiments of the disclosure with reference to the drawings.

FIG. 1 is a perspective view illustrating an optical connector cable according to an embodiment.

FIG. 2 is a perspective view illustrating a state before an optical fiber cable is attached to a circuit board and a lens module in the optical connector cable illustrated in FIG. 1.

FIG. 3 is a cross-sectional view when a part of the optical connector cable illustrated in FIG. 1 is cut along line III-III.

FIG. 4 is a plan view of the lens module of the optical connector cable illustrated in FIG. 1 as viewed from above.

FIG. 5 is a perspective view illustrating a holding portion attached to the optical fiber cable.

FIG. 6 is a view of a distal end portion of each of optical fibers placed in the lens module as viewed from above the lens module.

FIG. 7 is a view illustrating a relationship between a separation distance from a facing surface of the lens module to a central position for distal end surfaces of the optical fibers, and a bubble generation rate in an adhesive.

FIG. 8 is a flowchart illustrating a method for manufacturing an optical connector cable.

### DETAILED DESCRIPTION

### Problem to be Solved by Present Disclosure

In the lens module described in JP2016-035484A, a distal end surface of each of optical fibers is subjected to positioning such that it comes into contact with an abutment surface of a lens module, and an adhesive is injected into clearances between fiber grooves and end portions of the optical fibers. At this time, ideally, there is no clearance between the distal end surface of each of the optical fibers and the abutment surface. Thus, the adhesive does not enter a space between the distal end surface of each of the optical fibers and the abutment surface. However, actually, a manufacturing error (deviation) to a great or small extent may occur at a position of each of the distal end surfaces of the plurality of optical fibers, the adhesive may enter minute regions between the distal end surfaces of some optical fibers and the abutment surface, and bubbles may be generated inside the adhesive. If such bubbles are positioned inside the adhesive (particularly, on optical axes of the optical fibers), there is concern of occurrence of an optical axis deviation of the optical fibers, a Fresnel loss, or the like. Hence, it is desired to reduce generation of bubbles in an adhesive in an optical connector cable when a plurality of optical fibers are optically coupled.

### Effects of Present Disclosure

According to the present disclosure, it is possible to provide an optical connector cable and a method for manufacturing an optical connector cable, in which generation of bubbles in an adhesive can be reduced.

### DESCRIPTION OF EMBODIMENT OF PRESENT DISCLOSURE

First, details of embodiments of the present disclosure will be enumerated and described. An optical connector cable according to an embodiment includes a plurality of optical fibers, a lens module, and an adhesive. The plurality of optical fibers each extend in a first direction. The lens module has a placement portion, a facing surface, and a plurality of lenses. The placement portion is configured to place end portions of the plurality of optical fibers thereon in order in a second direction intersecting the first direction. The facing surface faces distal end surfaces of the plurality of optical fibers. The plurality of lenses are optically coupled to the plurality of optical fibers through the facing surface. The adhesive fixes the plurality of optical fibers to the placement portion. The plurality of optical fibers are placed on the placement portion such that the distal end surfaces are separated from the facing surface by predetermined distances, and a part of the adhesive enters spaces between the distal end surfaces and the facing surface.

In this optical connector cable, the plurality of optical fibers are placed on the placement portion such that each of the distal end surfaces is separated from the facing surface of the lens module by a predetermined distance. In this optical connector cable, the distal end surface of each of the optical fibers and the facing surface of the lens module are set in advance such that they are separated from each other by a predetermined distance. Thus, bubbles incorporated into the adhesive which has entered a space between the distal end surface of each of the optical fibers and the facing surface of the lens module are easily removed from the adhesive before curing or the like proceeds. According to this optical connector cable, generation of bubbles in an adhesive can be reduced. Therefore, an optical connection loss such as an optical axis deviation of the optical fibers or a Fresnel loss caused by bubbles can be curbed.

As one embodiment, the plurality of optical fibers may include optical fibers differing in separation distances from the distal end surfaces to the facing surface. Focal positions of the plurality of lenses may be positioned between the facing surface and a first distal end surface of a first optical fiber having the shortest separation distance in the plurality of optical fibers. According to this embodiment, since focal points of the lenses are positioned on optical paths between the lenses and the optical fibers which are optically coupled to each other, efficiency of optical coupling between the lenses and the optical fibers can be improved.

As one embodiment, a center in the first direction between the first distal end surface and a second distal end surface of a second optical fiber having the longest separation distance from the distal end surfaces to the facing surface may be positioned at an ideal central position when the plurality of optical fibers are placed on the placement portion such that a bubble generation rate in the adhesive is minimized, or may be positioned farther away from the facing surface than the ideal central position. According to this embodiment, the distal end surface provided in each of the optical fibers is positioned in the vicinity of the ideal central position or farther away from the facing surface than the ideal central position. Accordingly, the distal end surface of each of the optical fibers and the facing surface of the lens module are sufficiently separated from each other, and bubbles incorporated into the adhesive are more easily removed. Thus, generation of bubbles in an adhesive can be further reduced.

As one embodiment, the separation distances from the distal end surfaces to the facing surface may be equal to or greater than 25 μm and equal to or less than 50 μm. According to this embodiment, the distal end surface provided in each of the optical fibers is positioned moderately away from the facing surface. Thus, generation of bubbles in an adhesive can be reduced and an optical connection loss can be curbed. More specifically, when the separation distances from the distal end surfaces to the facing surface are shorter than 25 μm, since clearances between the distal end surfaces and the facing surface are extremely small, it takes time to remove bubbles from the adhesive which has entered the clearances or it is difficult to sufficiently remove bubbles. However, bubbles are easily eliminated by causing the separation distances from the distal end surfaces to the facing surface to be equal to or greater than 25 μm. In addition, when the separation distances from the distal end surfaces to the facing surface are greater than 50 μm, although the elimination of bubbles per unit volume is easier, the amount of the adhesive entering the clearances between the distal end surfaces and the facing surface increases and the total amount of bubbles between the distal end surfaces and the facing surface increases. Thus, the total amount of bubbles can be reduced by causing the separation distances from the distal end surfaces to the facing surface to be equal to or less than 50 μm.

As one embodiment, the optical connector cable may further include a circuit board, a plurality of optical elements, and a holding portion. The circuit board may mount the lens module thereon. The plurality of optical elements may be disposed on the circuit board and optically coupled to the plurality of optical fibers through the plurality of lenses, respectively. The holding portion may hold the plurality of optical fibers and have an end surface where end portions of the plurality of optical fibers project. Each of the plurality of optical elements may perform photoelectric conversion of light incident from the corresponding optical fiber or perform photoelectric conversion of light emitted to the corresponding optical fiber. According to this embodiment, the end portion of each of the optical fibers projecting from the holding portion can be easily cut to a suitable length with reference to a reference end surface of the holding portion. In addition, the optical connector cable includes the optical elements performing photoelectric conversion of light. Thus, for example, an electrical signal from a device to which the optical connector cable is connected can be converted into an optical signal and it can be sent out to other devices.

As one embodiment, the adhesive may be a light-transmitting adhesive. According to this embodiment, attenuation of light passing through the inside of the adhesive which has entered a space between the distal end surface of each of the optical fibers and the facing surface of the lens module, can be curbed.

A method for manufacturing the optical connector cable according to the embodiment includes, placing the end portions of the plurality of optical fibers on the placement portion of the lens module, and applying an adhesive to the placement portions to fix the plurality of optical fibers to the lens module. In the placing, the end portions of the plurality of optical fibers are placed such that the center between the first and second distal end surfaces is positioned at the ideal central position or positioned farther away from the facing surface than the ideal central position.

In this method for manufacturing an optical connector cable, the plurality of optical fibers are respectively placed on the placement portion such that the distal end surfaces provided in each thereof is positioned in the vicinity of the ideal central position or farther away from the facing surface than the ideal central position. Accordingly, the distal end surface of each of the optical fibers and the facing surface of the lens module are moderately separated from each other, and bubbles incorporated into the adhesive are more easily removed. Thus, generation of bubbles in an adhesive can be reduced.

### DETAILS OF EMBODIMENT OF PRESENT DISCLOSURE

Specific examples of an optical connector cable and a method for manufacturing an optical connector cable according to the present disclosure will be described below with reference to the drawings. The present invention is not limited to these examples. The present invention is indicated by the claims, and it is intended to include all changes within meanings and a range equivalent to the claims. In description of the drawings, the same reference signs are applied to the same elements, and duplicate description thereof will be omitted.

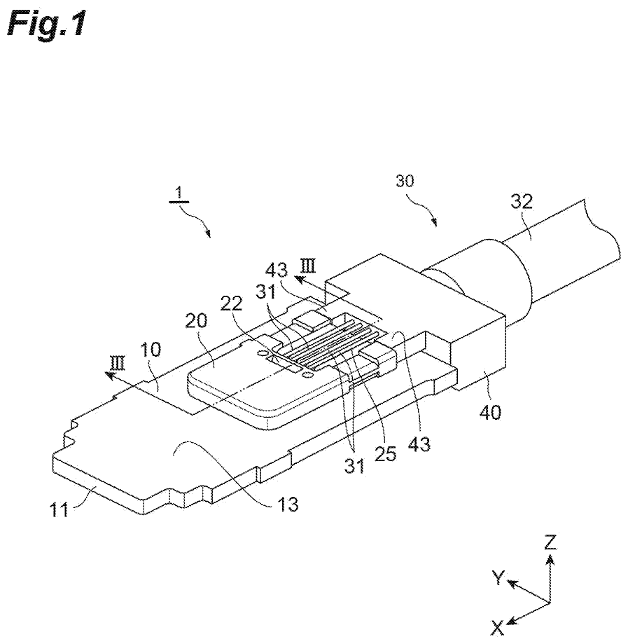

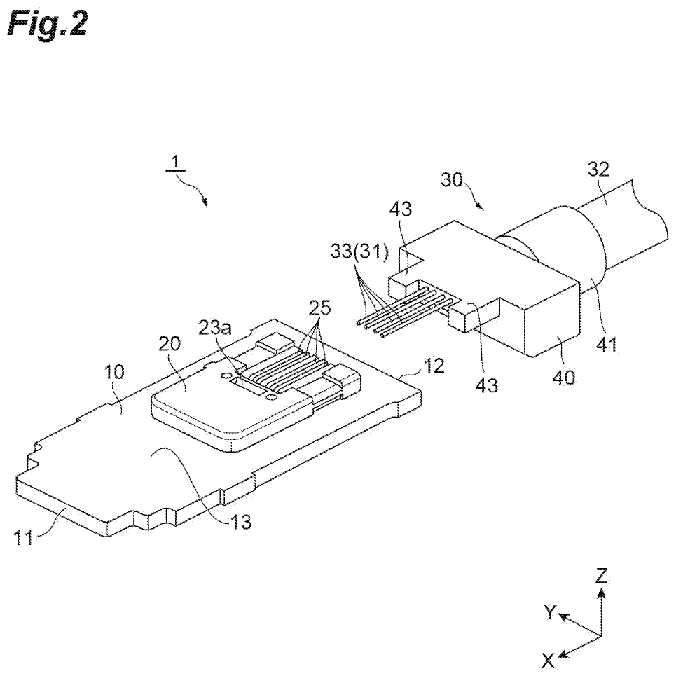

With reference to FIGS. 1 and 2, an optical connector cable according to the embodiment will be described. FIG. 1 is a perspective view illustrating the optical connector cable according to the embodiment. FIG. 2 is a perspective view illustrating a state before an optical fiber cable is attached to a circuit board and a lens module in the optical connector cable illustrated in FIG. 1. Hereinafter, for the sake of description, an extending direction of an end portion of the optical connector cable will be referred to as a direction X (first direction), a width direction of the end portion will be referred to as a direction Y (second direction), and a thickness direction of the end portion will be referred to as a direction Z. The direction X, the direction Y, and the direction Z intersect (in the present embodiment, are orthogonal to) each other.

For example, the optical connector cable 1 is used for transmitting and receiving optical signals between devices, and is an active optical cable (AOC), for example. As illustrated in FIGS. 1 and 2, the optical connector cable 1 includes a circuit board 10, a lens module 20, an optical fiber cable 30, and a holding portion 40. FIGS. 1 and 2 illustrate one end of the optical connector cable 1, and the other end of the optical connector cable 1 may also have a similar constitution.

The circuit board 10 is a plate-shaped component in which optical elements and electronic elements are mounted or built. As illustrated in FIG. 2, the circuit board 10 has a first end surface 11 and a second end surface 12 facing each other in the direction X. In the following description, an end where the first end surface 11 is positioned in the direction X will be referred to as a distal end of the optical connector cable 1, and an end where the second end surface 12 is positioned in the direction X will be referred to as a base end of the optical connector cable 1. Various kinds of wirings (not illustrated) for electrically connecting optical elements, electronic elements, and the like may be provided inside the circuit board 10. The circuit board 10 has a main surface 13 that is a flat surface extending in the direction X and the direction Y. The lens module 20 is placed in a region closer to the second end surface 12 on the main surface 13. The lens module 20 may be fixed to the main surface 13 using an adhesive. For example, the adhesive may be a UV curable adhesive.

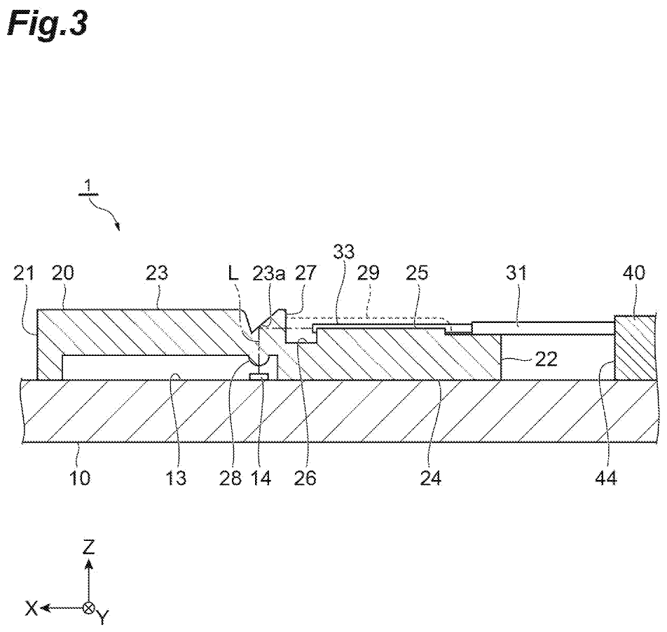

A plurality of optical elements 14 are mounted on the main surface 13 (refer to FIG. 3). The plurality of optical elements 14 are disposed in the direction Y and are covered with the lens module 20. Each of the optical elements 14 is optically coupled to a corresponding optical fiber 31 with the lens module 20 therebetween. The optical elements 14 perform photoelectric conversion of light L incident from the corresponding optical fibers 31 or perform photoelectric conversion of light L emitted to the corresponding optical fibers 31. For example, the optical elements 14 are light receiving elements such as photodiodes (PDs) or light emitting elements such as vertical cavity surface emitting lasers (VCSELs). In the following description, an example of a case in which the optical elements 14 are light receiving elements will be described.

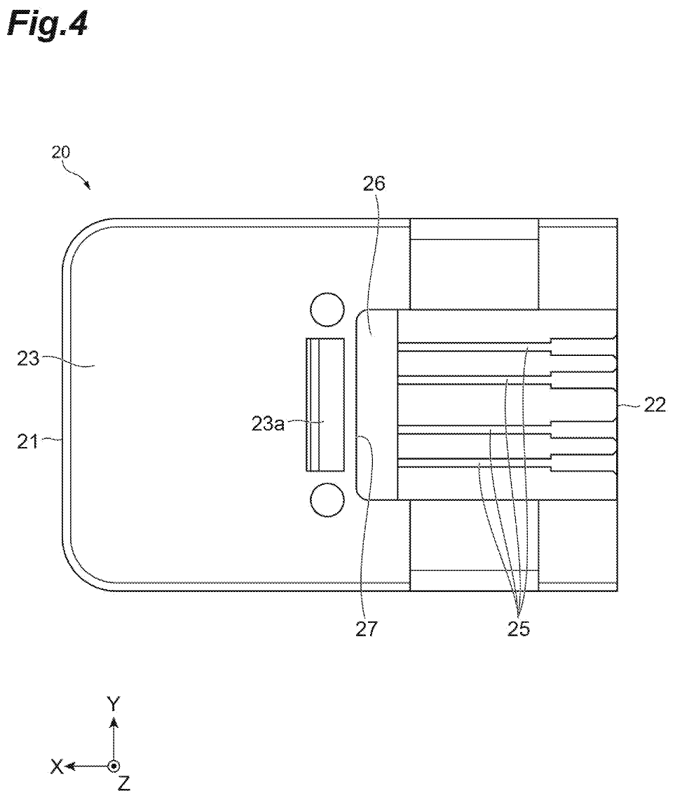

The lens module 20 is a plate-shaped component placed on the circuit board 10, and optically couples the optical fibers 31 with the optical elements 14. With reference to FIGS. 3 and 4, a detailed constitution of the lens module 20 will be described. FIG. 3 is a cross-sectional view when the lens module 20 disposed on the circuit board 10 is cut along line III-III. FIG. 4 is a plan view of the lens module 20 provided in the optical connector cable 1 as viewed from above. As illustrated in FIG. 3, the lens module 20 converts a propagation direction of the light L emitted from the optical fibers 31 in the direction X into a direction directed in the direction Z. The light L of which the propagation direction is converted passes through lenses 28 of the lens module 20 and is incident on the optical elements 14 on the circuit board 10. The lens module 20 is formed of a material transmitting the light L emitted from the optical fibers 31, for example, a glass or a light-transmitting resin. The lens module 20 has a first end surface 21, a second end surface 22, the upper surface 23, a lower surface 24, a plurality of fiber grooves 25, a recessed portion 26, a facing surface 27, and a plurality of lenses 28.

As illustrated in FIG. 3, the first end surface 21 is positioned on the distal end of the lens module 20. The first end surface 21 extends in the direction Y and the direction Z and is opposite to the second end surface 22 in the direction X. The second end surface 22 is positioned on the base end of the lens module 20. The second end surface 22 extends in the direction Y and the direction Z and is opposite to the first end surface 21 in the direction X. The lens module 20 may be a small-sized component of which the length from the first end surface 21 to the second end surface 22 in the direction X is equal to or greater than 4 mm and equal to or less than 12 mm, for example. The upper surface 23 is positioned at an upper portion of the lens module 20 and extends in the direction X and the direction Y. An end portion provided on the upper surface 23 closer to the first end surface 21 is connected to the first end surface 21, and an end portion closer to the second end surface 22 is connected to the facing surface 27. In addition, a recess having a mirror 23a is provided in a region on the upper surface 23 closer to the second end surface 22. The mirror 23a converts the propagation direction of the light L emitted from the optical fibers 31. The mirror 23a is inclined with respect to each of an XY plane and a YZ plane. The mirror 23a reflects the light L emitted from the optical fibers 31 in the direction X toward the lenses 28 and the optical elements 14. For example, an incident optical axis and a reflection optical axis of the light L may form a right angle.

The lower surface 24 is positioned at a lower portion of the lens module 20 and extends in the direction X and the direction Y. The lower surface 24 is provided closer to the second end surface 22 than to the upper surface 23 in the direction X, and an end portion of the lower surface 24 closer to the second end surface 22 is connected to the second end surface 22. In a state in which the lens module 20 is placed on the circuit board 10, the lower surface 24 comes into contact with the main surface 13 of the circuit board 10.

The plurality of fiber grooves 25 are a placement portion in which distal end parts 33 (end portions) of a plurality of optical fibers 31 are placed. Each of the fiber grooves 25 is a V groove extending in the direction X (a groove having a V-shape in a YZ plane). Each of the fiber grooves 25 regulates the position of one of the optical fibers 31 with respect to the lens module 20 and prevents misalignment of each of the optical fibers 31 in the direction Y. As illustrated in FIG. 3, an adhesive 29 is injected into the plurality of fiber grooves 25 and the recessed portion 26 adjacent to the plurality of fiber grooves 25, and thus the plurality of optical fibers 31 are fixed to the lens module 20. In the present embodiment, for the sake of convenience of description, the adhesive 29 is illustrated by a dashed line. The adhesive 29 is a light-transmitting adhesive transmitting the light L emitted from the optical fibers 31. The adhesive 29 may be a UV curable adhesive. As illustrated in FIG. 3, the adhesive 29 may be injected to the extent that a great part of an outer surface thereof reaches a height between upper surfaces of the optical fibers 31 and the upper surface 23 of the lens module 20.

As illustrated in FIG. 4, the plurality of fiber grooves 25 are arranged in the direction Y. The number of fiber grooves 25 may be the same as the number of optical fibers 31 or may be larger than the number thereof. In the present embodiment, the number of fiber grooves is the same as the number of optical fibers 31 and is four, for example. An end portion of each of the fiber grooves 25 closer to the first end surface 21 is connected to the recessed portion 26, and an end portion of each of the fiber grooves 25 closer to the second end surface 22 opens on the second end surface 22. For example, the distal end part 33 of each of the optical fibers 31 is accommodated inside the fiber groove 25 through an opening of each of the fiber grooves 25 provided on the second end surface 22. Each of the fiber grooves 25 is formed such that the width of a part closer to the second end surface 22 in the direction Y is larger than the width of a part closer to the first end surface 21 in the direction Y. Accordingly, each of the optical fibers 31 can be easily accommodated inside one of the fiber grooves 25 through the opening of each of the fiber grooves 25 on the second end surface 22. The shape of each of the fiber grooves 25 is not limited to a V groove. For example, it may be a U groove having a rounded bottom portion or a rectangular groove having a bottom surface extending in the direction X and the direction Y. The placement portion in which the optical fibers 31 are placed may not exhibit a groove shape such as the fiber groove 25. For example, a plurality of projection portions arranged in the direction Y may be formed on a flat surface, as another example of the placement portion, and each of the optical fibers 31 may be placed such that it is sandwiched between projection portions adjacent to each other.

As illustrated in FIG. 3, the recessed portion 26 is a groove provided between the fiber grooves 25 and the facing surface 27 in the direction X and is recessed in the direction Z. As illustrated in FIG. 4, the recessed portion 26 linearly extends in the direction Y. A bottom surface of the recessed portion 26 is a flat surface lying in the direction X and the direction Y. The depth of the recessed portion 26 may be larger than the depth of each of the fiber grooves 25. That is, in the direction Z, the bottom surface of the recessed portion 26 may be positioned below the bottom portion of each of the fiber grooves 25 (closer to the lower surface 24). The adhesive 29 is injected into the recessed portion 26 to fix the optical fibers 31 to the lens module 20. As illustrated in FIG. 3, a part of the adhesive 29 enters a space between the facing surface 27 of the lens module 20 and a distal end surface of each of the optical fibers 31.

As illustrated in FIG. 3, the facing surface 27 faces the distal end surface of each of the optical fibers 31 in the direction X and extends in the direction Y and the direction Z. The facing surface 27 connects the upper surface 23 and the bottom surface of the recessed portion 26. The light L emitted from the optical fibers 31 passes through the facing surface 27 and is incident on the mirror 23a. The facing surface 27 does not directly contact with each of the optical fibers 31 and is separated from each of the optical fibers 31.

The plurality of lenses 28 are optically coupled to the optical elements 14, respectively. As illustrated in FIG. 3, each of the lenses 28 is provided at a position overlapping the mirror 23a and the corresponding optical element 14 on an optical path in the direction Z. Each of the lenses 28 has an outer surface curved in a convex shape downward, that is, toward the optical element 14. Each of the lenses 28 causes the light L reflected by the mirror 23a to be converged and incident on the corresponding optical element 14. For example, a focal point of each of the lenses 28 is positioned on the outer surface of the optical element 14 or on a side inward from the outer surface of the optical element 14. Various parameters of the lenses 28, for example, shapes of the outer surfaces, sizes, and materials of the lenses 28, are optimized on the basis of relative positions between the lenses 28 and the optical elements 14, or the like.

Returning to FIGS. 1 and 2, description of other components included in the optical connector cable 1 will be continued. The optical fiber cable 30 has the plurality of optical fibers 31 and a cable sheath 32. Each of the optical fibers 31 is a member for transferring an optical signal. In each of the optical fibers 31, a great part thereof is accommodated inside the cable sheath 32 and the distal end part 33 is exposed to the outside of the cable sheath 32. In the distal end part 33 of each of the optical fibers 31, the fiber pitch and the extending direction are determined by the holding portion 40. In the present embodiment, the distal end parts 33 of the optical fibers 31 are arrayed in a separated manner such that they are parallel to each other. The distal end part 33 of each of the optical fibers 31 is accommodated in each of the fiber grooves 25 provided in the lens module 20.

Each of the optical fibers 31 may be formed by covering a glass fiber constituted of a core and a cladding surrounding the core with a resin, for example. Each of the optical fibers 31 may be a single mode optical fiber (SMF) or a multi-mode optical fiber (MMF). In the present embodiment, the optical fiber cable 30 has four optical fibers 31, but the number of optical fibers 31 is not limited.

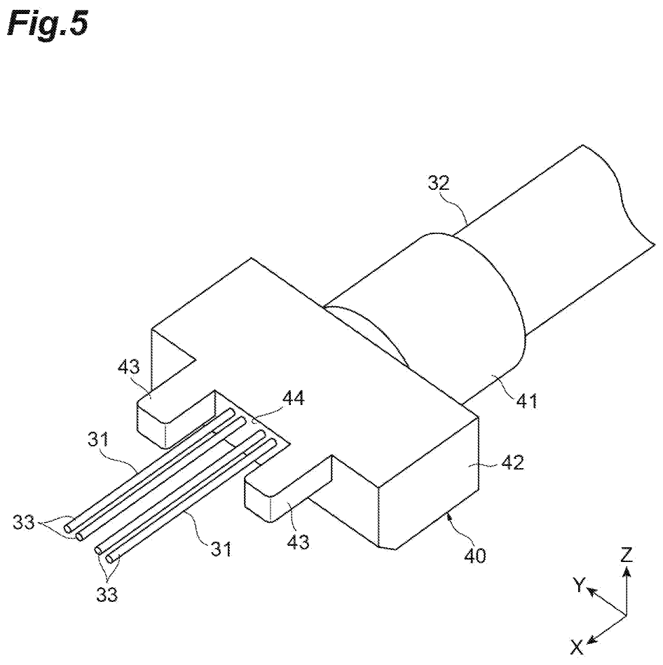

The holding portion 40 is a member collectively holding the plurality of optical fibers 31. With reference to FIG. 5, a detailed constitution of the holding portion 40 will be described. FIG. 5 is a perspective view illustrating the holding portion 40 attached to the optical fiber cable 30. As illustrated in FIG. 5, the holding portion 40 has a cylinder portion 41, a main body portion 42, a pair of protruding portions 43, and a reference end surface 44. For example, the holding portion 40 is formed by disposing the plurality of optical fibers 31 inside a mold and performing resin molding. The cylinder portion 41 is a member exhibiting a cylindrical shape and accommodates the plurality of optical fibers 31 therein. The main body portion 42 is a member exhibiting substantially a rectangular parallelepiped shape and accommodates the plurality of optical fibers 31 together with the cylinder portion 41. Inside the cylinder portion 41 and the main body portion 42, the array form of the plurality of optical fiber 31 changes. Specifically, inside the cylinder portion 41, the plurality of optical fibers 31 are in tight contact with each other and are arranged in a bundle shape. However, inside the main body portion 42, the plurality of optical fibers 31 are separated from each other as they go toward the distal end and change to an array form in which they are arranged in a one-dimensional shape in the direction Y.

The pair of protruding portions 43 are members protruding from the outer surface of the main body portion 42 toward the distal end side in the direction X. As illustrated in FIG. 1, in a state in which the optical fiber cable 30 is fixed to the lens module 20, lower surfaces of the pair of protruding portions 43 are individually placed on the main surface 13 of the circuit board 10. The pair of protruding portions 43 are used for positioning of the optical fiber cable 30 with respect to the circuit board 10 in the direction Z. The lower surface of each of the protruding portions 43 and the main surface 13 of the circuit board 10 may be fixed to each other using an adhesive, for example.

The reference end surface 44 is provided between the pair of protruding portions 43 and extends in the direction Y and the direction Z. The plurality of optical fibers 31 project from the reference end surface 44 toward the distal end. The extending direction of each of the optical fibers 31 projecting from the reference end surface 44 and the extending direction of the reference end surface 44 may form a right angle, for example. Each of the optical fibers 31 may be cut to have a desired length on the basis of the length from the reference end surface 44 to the distal end surface of each of the optical fibers 31, for example. The foregoing members constituting the holding portion 40, which are the cylinder portion 41, the main body portion 42, and the pair of protruding portions 43, may be integrally formed by performing injection molding of a resin (e.g. a polyamide resin).

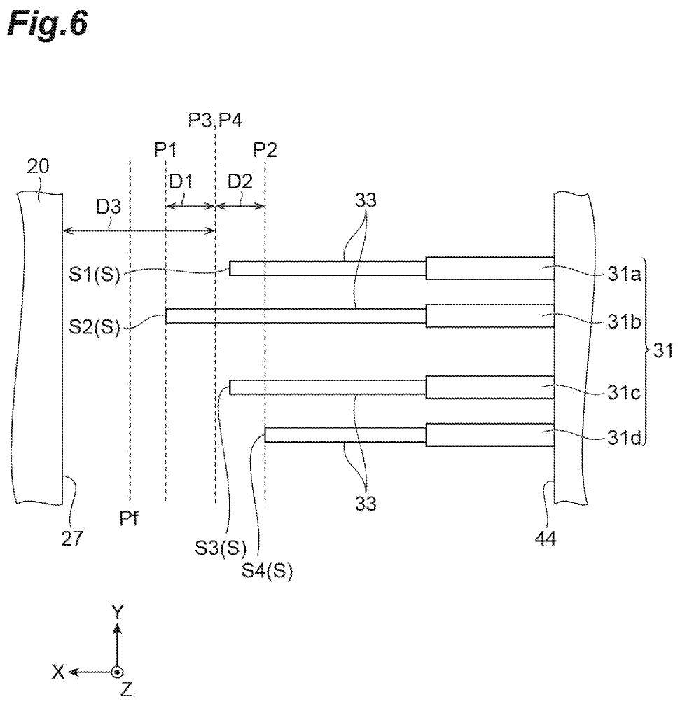

Next, with reference to FIG. 6, a positional relationship between the facing surface 27 of the lens module 20 and the distal end part 33 of each of the optical fibers 31 will be described. FIG. 6 is a view of the distal end part 33 of each of the optical fibers 31 placed in the lens module 20 as viewed from above the lens module 20 (from the upper surface 23 illustrated in FIG. 3). In FIG. 6, for the sake of convenience of description, illustration of each of the fiber grooves 25, the adhesive 29, and the like of the lens module 20 is omitted.

The plurality of optical fibers 31 include an optical fiber 31a, an optical fiber 31b, an optical fiber 31c, and an optical fiber 31d, and are placed side by side in the direction Y. The optical fiber 31a has a distal end surface S1, the optical fiber 31b has a distal end surface S2, the optical fiber 31c has a distal end surface S3, and the optical fiber 31d has a distal end surface S4. In the following description, the distal end surface S1 to the distal end surface S4 will be generically referred to as “distal end surfaces S”.

The distal end surfaces S of the optical fibers 31 are positioned such that they are separated from the facing surface 27 by predetermined distances. Although illustration is omitted in FIG. 6, a part of the adhesive 29 enters spaces between the distal end surfaces S of the optical fibers 31 and the facing surface 27 of the lens module 20. Light emitted from the distal end surfaces S of the optical fibers 31 passes through the adhesive 29 and the facing surface 27, and is incident on the inside of the lens module 20. The plurality of optical fibers 31 are cut by setting manufacturing conditions such that positions of the distal end surfaces S are aligned in the direction X (such that all the distal end surfaces S are positioned within the same YZ plane). However, due to a manufacturing error at the time of cutting, a slight deviation occurs at a cut position of each of the optical fibers 31. Such a manufacturing error is equal to or greater than 5 μm and equal to or less than 50 μm, for example. For this reason, when each of the optical fibers 31 is placed in the lens module 20, as illustrated in FIG. 6, unevenness occurs at the positions of the distal end surfaces S. In other words, separation distances between the distal end surfaces S of the respective optical fibers 31 and the facing surface 27 of the lens module 20 are subtly different from each other.

Here, a position of the distal end surface S (first distal end surface) having the shortest separation distance to the facing surface 27 in the direction X will be referred to as a first position P1. In the present embodiment, the position of the distal end surface S2 becomes the first position P1. A position of the distal end surface S (second distal end surface) having the longest separation distance to the facing surface 27 in the direction X will be referred to as a second position P2. In the present embodiment, the position of the distal end surface S4 becomes the second position P2. A position where a distance D1 from the first position P1 and a distance D2 from the second position P2 become equivalent to each other in the direction X will be referred to as a central position P3. The distal end surface S1 and the distal end surface S3 respectively provided in the optical fiber 31a and the optical fiber 31c are positioned between the first position P1 and the second position P2 in the direction X. In the present embodiment, the distal end surface S1 and the distal end surface S3 are present substantially at the same position in the direction X. The plurality of lenses 28 provided in the lens module 20 (refer to FIG. 3) are optically coupled to the plurality of respective optical fibers 31. Focal positions Pf of the plurality of respective lenses 28 are set such that it is positioned between the facing surface 27 and the first position P1 in the direction X.

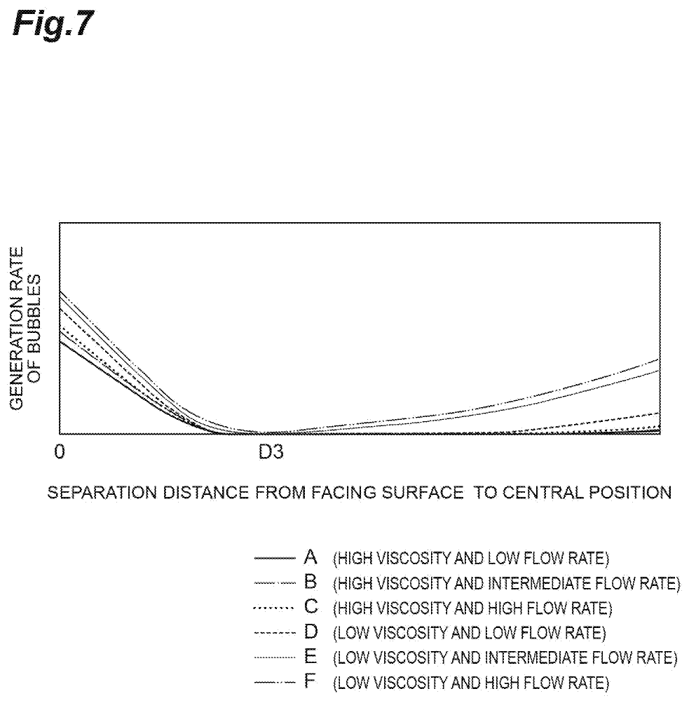

As described above with reference to FIG. 3, the adhesive 29 is injected into spaces between the distal end surfaces S of the optical fibers 31 and the facing surface 27 of the lens module 20. Since the adhesive 29 before being cured has fluidity, bubbles may be generated inside the adhesive 29. Bubbles include not only air incorporated into the adhesive 29 but also voids generated in the interfaces between the optical fibers 31 and the adhesive 29. For example, these voids are generated due to volume change at the time of curing of the adhesive 29 and deviation of the adhesive 29 from the outer surfaces of the optical fibers 31. If such bubbles are present in the adhesive 29 (particularly, on the optical paths of the optical fibers 31), there is concern of occurrence of an optical axis deviation, a Fresnel loss, or the like. For this reason, it is preferable that fewer bubbles be generated in the adhesive 29. According to knowledge of the inventors, as illustrated in FIG. 7, a generation rate of bubbles in the adhesive 29 varies in accordance with the separation distances between the facing surface 27 of the lens module 20 and the distal end surfaces S of the optical fibers 31. With reference to FIG. 7, change in the generation rate of bubbles according to the separation distances between the facing surface 27 and the distal end surfaces S will be specifically described.

FIG. 7 is a graph illustrating a relationship between the separation distance from the facing surface 27 of the lens module 20 to the central position P3 (refer to FIG. 6) for the distal end surfaces S provided in the optical fibers 31 and the generation rate of bubbles in the adhesive 29. The horizontal axis indicates the separation distance from the facing surface 27 of the lens module 20 to the central position P3 for the distal end surfaces S provided in the optical fibers 31. The vertical axis indicates the generation rate of bubbles in the adhesive 29 after being cured. That is, FIG. 7 illustrates results obtained by varying the positions of the optical fibers 31 in the direction X (specifically, the central position P3) and measuring the generation rate of bubbles. This measurement was performed under a plurality of conditions in which the viscosity of the adhesive 29 and the flow rate at the time of injecting the adhesive 29 were varied. The line A in FIG. 7 indicates a measurement result when the adhesive 29 having a high viscosity was injected at a low flow rate (low flow rate), the line B indicates a measurement result when the adhesive 29 having a high viscosity was injected at a higher flow rate (intermediate flow rate) than that in the condition according to the line A, and the line C indicates a measurement result when the adhesive 29 having a high viscosity was injected at a further higher flow rate (high flow rate) than that in the condition according to the line B. The line D indicates a measurement result when the adhesive 29 having a low viscosity was injected at a low flow rate (low flow rate), the line E indicates a measurement result when the adhesive 29 having a low viscosity was injected at a higher flow rate (intermediate flow rate) than that in the condition according to the line D, and the line F indicates a measurement result when the adhesive 29 having a low viscosity was injected at a further higher flow rate (high flow rate) than that in the condition according to the line E.

As illustrated in FIG. 7, under all conditions, the generation rate of bubbles has decreased when the separation distance from the facing surface 27 to the central position P3 was gradually increased from a distance 0 (zero), and the generation rate of bubbles has gently increased when the separation distance exceeds a distance D3. That is, when each of the optical fibers 31 is placed in the lens module 20 such that the central position P3 is separated from the facing surface 27 by the distance D3, the generation rate of bubbles in the adhesive 29 can be minimized. The central position P3 where the generation rate of bubbles is minimized will be referred to as an ideal central position P4. As illustrated in FIG. 7, the generation rate of bubbles becomes lower in a case of using the adhesive 29 having a high viscosity than in a case of using the adhesive 29 having a low viscosity. When the adhesive 29 having the same viscosity is used, the generation rate of bubbles becomes lower in a case of a low flow rate than in a case of a high flow rate at the time of injecting the adhesive 29.

As illustrated in FIG. 6, the optical fibers 31 according to the present embodiment are placed in the lens module 20 such that the central position P3 coincides with the ideal central position P4. The optical fibers 31 are not necessarily placed such that the central position P3 completely coincides with the ideal central position P4. For example, the central position P3 may be positioned farther away from the facing surface 27 than the ideal central position P4 or may be positioned slightly closer to the facing surface 27 than the ideal central position P4. For example, the separation distance from the facing surface 27 to the central position P3 may be 35 μm, or may be equal to or greater than 30 μm and equal to or less than 40 μm. For example, the separation distance from the facing surface 27 to the first position P1 may be 30 μm, or may be equal to or greater than 25 μm and equal to or less than 35 μm. For example, the separation distance from the facing surface 27 to the second position P2 may be 40 μm, or may be equal to or greater than 35 μm and equal to or less than 50 μm.

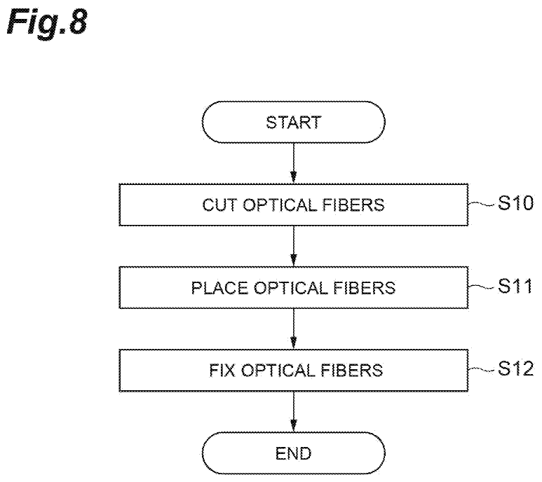

FIG. 8 is a flowchart illustrating a method for manufacturing the optical connector cable 1. With reference to FIG. 8, a method for manufacturing the foregoing optical connector cable 1 will be described. First, the plurality of optical fibers 31 are cut such that lengths from the reference end surface 44 to the distal end surfaces S match predetermined sizes (Step S10). Specifically, as illustrated in FIG. 6, the optical fibers 31 are cut to have lengths such that the central position P3 for the distal end surfaces S provided in the optical fibers 31 can be positioned at the ideal central position P4.

Next, the distal end parts 33 of the plurality of optical fibers 31 are individually placed in the plurality of fiber grooves 25 provided in the lens module 20 (Step S11). At this time, as illustrated in FIG. 6, the optical fibers 31 are placed such that the central position P3 for the distal end surfaces S provided in the optical fibers 31 is positioned at the ideal central position P4. The central position P3 for the optical fibers 31 does not necessarily completely coincide with the ideal central position P4 and may be positioned farther away from the facing surface 27 than the ideal central position P4. When the optical fibers 31 are placed, as illustrated in FIGS. 1 and 2, positioning of the optical fibers 31 in the direction Z may be performed by causing the lower surfaces of the pair of protruding portions 43 provided in the holding portion 40 to abut the main surface 13 of the circuit board 10.

Next, the adhesive 29 is applied to the lens module 20, and the distal end part 33 of each of the optical fibers 31 is fixed to the lens module 20 (Step S12). Specifically, as illustrated in FIG. 3, a state in which each of the optical fibers 31 is placed in each of the fiber grooves 25, the adhesive 29 is injected into each of the fiber grooves 25 and the recessed portion 26. At this time, in order to curb generation of bubbles inside the adhesive 29, the adhesive 29 having a high viscosity may be injected at a low flow rate. A step of manufacturing the optical connector cable 1 hereby ends.

Hereinabove, in the optical connector cable 1 according to the present embodiment, the plurality of optical fibers 31 are placed in the fiber grooves 25 (the placement portion) such that the distal end surfaces S are separated from the facing surface 27 of the lens module 20 by predetermined distances. In other words, it is constituted such that all the optical fibers 31 of the optical fiber cable 30 are separated from the facing surface 27. In this manner, in the optical connector cable 1, the distal end surface S of each of the optical fibers 31 and the facing surface 27 of the lens module 20 are set in advance such that they are separated from each other by a predetermined distance, and thus bubbles incorporated into the adhesive 29 which has entered a space between the distal end surface S of each of the optical fibers 31 and the facing surface 27 of the lens module 20 are easily removed from the adhesive 29 before curing or the like. According to this optical connector cable 1, the generation rate of bubbles in the adhesive 29 can be reduced. For this reason, occurrence of defects caused by bubbles, such as an optical axis deviation of the optical fibers 31 or a Fresnel loss can be curbed.

In the foregoing embodiment, the plurality of optical fibers 31 include optical fibers (the optical fiber 31a to the optical fiber 31d) differing in separation distances from the distal end surfaces S to the facing surface 27. The focal positions Pf of the plurality of lenses 28 are positioned between the facing surface 27 and the first position P1 of the distal end surface S2 provided in the optical fiber 31b having the shortest separation distance in the direction X. Accordingly, since the focal points of the lenses 28 are positioned on the optical paths between the lenses 28 and the optical fibers 31 which are optically coupled to each other, efficiency of optical coupling between the lenses 28 and the optical fibers 31 can be improved.

In the foregoing embodiment, the central position P3 between the first position P1 of the distal end surfaces S provided in the plurality of optical fibers 31 and the second position P2 of the distal end surface S4 provided in the optical fiber 31d having the longest separation distance from the distal end surfaces S to the facing surface 27 in the direction X, is positioned at the ideal central position P4 or is positioned farther away from the facing surface 27 than the ideal central position P4. Accordingly, each of the distal end surfaces S provided in each of the optical fibers 31 is positioned in the vicinity of the ideal central position P4 or farther away from the facing surface 27 than the ideal central position P4. For this reason, the distal end surface S of each of the optical fibers 31 and the facing surface 27 of the lens module 20 are sufficiently separated from each other, and bubbles incorporated into the adhesive 29 are more easily removed. Thus, the generation rate of bubbles can be further reduced.

In the foregoing embodiment, the separation distances from the distal end surfaces S to the facing surface 27 may be equal to or greater than 25 μm and equal to or less than 50 μm. Accordingly, the distal end surfaces S provided in the optical fibers 31 are positioned moderately away from the facing surface 27. Thus, the generation rate of bubbles in the adhesive 29 can be reduced.

In the foregoing embodiment, the optical connector cable 1 includes the circuit board 10, the plurality of optical elements 14, and the holding portion 40. The circuit board 10 mounts the lens module 20 thereon. The plurality of optical elements 14 are disposed on the circuit board 10 and optically coupled to the plurality of optical fibers 31 through the plurality of lenses 28 therebetween. The holding portion 40 has the reference end surface 44 having end portions of the plurality of optical fibers 31 projecting thereon and collectively holds the plurality of optical fibers 31. Each of the plurality of optical elements 14 performs photoelectric conversion of light incident from the corresponding optical fiber 31 or performs photoelectric conversion of light emitted to the corresponding optical fiber 31. Accordingly, the distal end part 33 of each of the optical fibers 31 projecting from the holding portion 40 can be easily cut to a suitable length with reference to the reference end surface 44 of the holding portion 40. In addition, the optical connector cable 1 includes the optical elements 14 each performing photoelectric conversion of light. Accordingly, for example, an electrical signal from a device to which the optical connector cable 1 is connected can be converted into an optical signal and it can be sent out to other devices. That is, a communication speed between devices connected to each other by the optical connector cable 1 can be improved.

In the foregoing embodiment, the adhesive 29 is a light-transmitting adhesive. Accordingly, attenuation of light passing through the inside of the adhesive 29 which has entered a space between the distal end surface S of each of the optical fibers 31 and the facing surface 27 of the lens module 20 can be curbed.

In the method for manufacturing the optical connector cable 1 according to the present embodiment, each of the optical fibers 31 is placed in each of the fiber grooves 25 (the placement portion) such that the central position P3 for the distal end surfaces S provided in the optical fibers 31 is positioned at the ideal central position P4 or is positioned farther away from the facing surface 27 than the ideal central position P4. Accordingly, each of the distal end surfaces S provided in each of the optical fibers 31 is positioned in the vicinity of the ideal central position P4 or farther away from the facing surface 27 than the ideal central position P4. For this reason, the distal end surface S of each of the optical fibers 31 and the facing surface 27 of the lens module 20 are sufficiently separated from each other, and bubbles incorporated into the adhesive 29 are more easily removed. Thus, the generation rate of bubbles in the adhesive 29 can be further reduced.

Hereinabove, the embodiments according to the present disclosure have been described in detail, but the present disclosure is not limited to the foregoing embodiments and can be applied to various embodiments. For example, the optical connector cable 1 according to the foregoing embodiments have a constitution in which the light L emitted from the optical fibers 31 is incident on the optical elements 14. However, when the optical elements 14 are light emitting elements such as VCSELs, the optical connector cable 1 may have a constitution in which the light L emitted from the optical elements 14 is incident on the optical fibers 31. At this time, the light L emitted from the optical elements 14 may be converted into collimate light (parallel light) by the lenses 28 and may be incident on the optical fibers 31 after being reflected by the mirror 23a.

What is claimed is:

1. An optical connector cable comprising:
a plurality of optical fibers each extending in a first direction;
a lens module that includes a placement portion configured to place end portions of the plurality of optical fibers thereon in order in a second direction intersecting the first direction, a facing surface facing distal end surfaces of the plurality of optical fibers, and a plurality of lenses optically coupled to the plurality of optical fibers through the facing surface; and
an adhesive fixing the plurality of optical fibers to the placement portion,
wherein the plurality of optical fibers are placed on the placement portion such that the distal end surfaces are separated from the facing surface by predetermined distances, and a part of the adhesive enters spaces between the distal end surfaces and the facing surface.

2. The optical connector cable according to claim 1,
wherein the plurality of optical fibers include optical fibers differing in separation distances from the distal end surfaces to the facing surface, and
wherein focal positions of the plurality of lenses are positioned between the facing surface and a first distal end surface of a first optical fiber having the shortest separation distance in the plurality of optical fibers.

3. The optical connector cable according to claim 2,
wherein a center in the first direction between the first distal end surface and a second distal end surface of a second optical fiber having the longest separation distance in the plurality of optical fibers, is positioned at an ideal central position when the plurality of optical fibers are placed on the placement portion such that a bubble generation rate in the adhesive is minimized, or is positioned farther away from the facing surface than the ideal central position.

4. The optical connector cable according to claim 1,
wherein the separation distances from the distal end surfaces to the facing surface are equal to or greater than 25 μm and equal to or less than 50 μm.

5. The optical connector cable according to claim 2,
wherein the separation distance from the facing surface to the first distal end surface is equal to or greater than 25 μm and equal to or less than 35 μm.

6. The optical connector cable according to claim 3,
wherein the separation distance from the facing surface to the second distal end surface is equal to or greater than 35 μm and equal to or less than 50 μm.

7. The optical connector cable according to claim 3,
wherein the separation distance from the facing surface to the center between the first and second distal end surfaces is equal to or greater than 30 μm and equal to or less than 40 μm.

8. The optical connector cable according to claim 1 further comprising:
a circuit board mounting the lens module thereon;
a plurality of optical elements disposed on the circuit board, the plurality of optical elements being optically coupled to the plurality of optical fibers through the plurality of lenses, respectively; and
a holding portion holding the plurality of optical fibers, the holding portion having an end surface where end portions of the plurality of optical fibers project,
wherein each of the plurality of optical elements performs photoelectric conversion of light incident from the corresponding optical fiber or performs photoelectric conversion of light emitted to the corresponding optical fiber.

9. The optical connector cable according to claim 1,
wherein the adhesive is a light-transmitting adhesive.

10. The optical connector cable according to claim 1,
wherein the lens module includes a recessed portion provided between the placement portion and the facing surface.

11. The optical connector cable according to claim 10,
wherein the placement portion includes fiber grooves that each places the plurality of optical fibers thereon, and
wherein the depth of the recessed portion is larger than the depth of each of the fiber grooves.

12. The optical connector cable according to claim 10,
wherein the adhesive is injected to the placement portion and the recessed portion.

13. A method for manufacturing the optical connector cable according to claim 3, the method comprising:
placing the end portions of the plurality of optical fibers on the placement portion of the lens module; and
applying an adhesive to the placement portion to fix the plurality of optical fibers to the lens module,
wherein, in the placing, the end portions of the plurality of optical fibers are placed such that the center between the first and second distal end surfaces is positioned at the ideal central position or positioned farther away from the facing surface than the ideal central position.
